(19) United States
(12) Patent Application Publication
(10) Pub. No.: US 2004/0233572 A1
(43) Pub. Date: Nov. 25, 2004

(54) Disk drive apparatus

(76) Inventors: Hitoshi Saito, Tokoy (JP); Hirotaka Ishikawa, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/825,103

(22) Filed: Apr. 16, 2004

(30) Foreign Application Priority Data
May 8, 2003 (JP) P2003-130904

(51) Int. Cl. G11B 17/00

(52) U.S. Cl. 360/97.01

(57) ABSTRACT

There is provided a disk drive apparatus that can improve aesthetic sense of the appearance of a drive apparatus and facilitate the installation and the detachment of an outer casing. A decorative panel is detachable so as to cover approximately the entire surface of an upper face of a drive body that is approximately parallel to a recording surface of a floppy disk. By preparing a variety of decorative panels having, for example, different patterns, colors or shapes, it is capable of providing a disk drive to user's taste. The installation and the detachment are easy to carry out because an engaging piece is disposed on a front face of the drive body and an engaging groove is disposed at a shorter-side member of the decorative panel.

### CROSS REFERENCE TO RELATED APPLICATION

This application claims priority from Japanese Priority Document No. 2003-130904, filed on May 8, 2003 with the Japanese Patent Office, which document is hereby incorporated by reference.

### BACKGROUND OF THE INVENTION

1. Field of the Invention

The present invention relates to a disk drive apparatus such as a floppy (registered Trademark) disk drive and the like.

2. Description of Related Art

Recently, there has been commercially available a drive apparatus of which outer casing is replaceable such that some of the outer casing of a disk drive apparatus such as a floppy disk drive has a pattern and a color of user's favorite. As an example, there is a disk drive apparatus of which outer casing is detached by sliding it. This is disclosed in the following URL:

http://macfannet.mycom.co.jp/news/0011/28/1128logitec fwdvd usbfd.html

(as of the filing date of this application in Japan).

### SUMMARY OF THE INVENTION

In the disk drive apparatus described in the above URL, the outer casing is detachable only by sliding it, and the detachment of the outer casing is easy. However, the outer casing can only be replaced in some portion of the top surface of a disk drive body of the drive apparatus. In some cases, a larger area or a larger number of replaceable outer casings may also improve aesthetic sense. In addition, it is anticipated that even for the same product, the preparation of a variety of such outer casings will enable to strongly show aesthetic sense of user depending on the selection of an outer casing.

In view of the above circumstances, the present invention is to provide a disk drive apparatus capable of improving aesthetic sense of the appearance for a drive device. The present invention is also to provide a disk drive apparatus capable of easily detaching the outer casing of a drive device.

A disk drive apparatus according to the present invention comprises a disk drive body including a front face having an insertion opening of a disk and side faces substantially parallel to a recording surface of the inserted disk, and a decorative panel covering approximately the entire surface of the side faces and being disposed so as to be detachable from the side faces.

In this invention, the decorative panel is detachable so as to cover approximately the entire surface of the side faces of the disk drive body that is substantially parallel to the recording surface of the inserted disk. It is able to provide a disk drive apparatus depending on user's taste by preparing, for example, a variety of decorative panels having different patterns, colors, or shapes. In many cases, the side faces of a disk drive body occupy the largest surface in the surface of its body. According to the present invention, it is therefore able to further improve aesthetic sense than the case with conventional ones. For example, even with disk drives having the same shape and the like, the aesthetic sense of user can be shown more strongly depending on the selection of a decorative panel, thereby improving seasoning of the user. Further, in the cases where a disk drive is used by connecting to a personal computer or the like, a decorative panel is selectable in accordance with the peripheral environment of the disk drive. Specifically, it is possible to have unification with the color and the pattern of the appearance of the personal computer.

In one aspect of the present invention, the above-mentioned decorative panel has a flat panel portion shaped as a rectangle by having a periphery thereof longer-sides and shorter-sides, shorter-side members disposed along the shorter-sides of the flat panel portion, longer-side members disposed along the longer-sides of the flat panel portion, and a first engaging piece or a first engaging groove for engagement with the above-mentioned disk drive body. If the first engaging piece is disposed at the shorter-sides members, for example, an engaging groove for engagement with the first engaging piece may be disposed on the disk drive body. If the first engaging groove is disposed at the shorter-sides members, for example, an engaging piece for engagement with the first engaging groove is disposed on the disk drive body. In this invention, the detachment of the decorative panel from the main body is easy by disposing the first engaging piece or the first engaging groove at the shorter-side members, instead of the longer-side members. In other words, as compared to the detachment of the decorative panel by hand from the side of one of the two longer-side members, the detachment of the decorative panel by hand from the side of one of the two shorter-side members can generate a greater moment of inertia, thereby facilitating the detachment. That is, the moment of inertia is increased by the amount of a difference between the longer-side length and the shorter-side length. If the decorative panel is gripped by hand, as compared to the gripping of the two shorter-side members, the gripping of the longer-side members can minimize stretching of fingers. This is true for the installation of the decorative panel into the disk drive body, and for the detachment therefrom, thereby facilitating the installation and the detachment of the decorative panel.

In other aspect of the present invention, the above-mentioned decorative panel has a plurality of above-mentioned first engaging pieces or above-mentioned first engaging grooves, and also has second engaging pieces for engagement with the above-mentioned disk drive body, the number of which is less than the number of the first engaging pieces or the first engaging grooves, and disposed at the above-mentioned longer-side members. In other aspect of the present invention, the above-mentioned decorative panel has a plurality of above-mentioned first engaging pieces or above-mentioned first engaging grooves, and has second engaging grooves for engagement with the above-mentioned disk drive body, the number of which is less than the number of the first engaging pieces or the first engaging grooves, and disposed at the above-mentioned longer-side members. By disposing the second engaging piece or the second engaging groove, it is avoidable, for example, that the decorative panel installed into the body departs suddenly, thereby retaining reliably the installed state. It is however preferable to minimize the number of the second engaging piece or the second engaging groove, in order to facilitate the detachment of the decorative panel. Specifically, it is preferable to employ primarily the first engaging pieces or the first engaging grooves and employ secondarily the second engaging piece or the second engaging groove. According to the present invention, the installed state can be retained reliably, while the detachment of the decorative panel is facilitated by reducing the number of the second engaging piece and the like than the number of the first engaging pieces and the like.

In other aspect of the present invention, the above-mentioned decorative panel is disposed at the above-mentioned longer-side members and has a second engaging piece for engagement with the above-mentioned disk drive body. The second engaging piece is formed so as to be smaller than the above-mentioned first engaging piece. In other aspect of the present invention, the above-mentioned decorative panel is disposed at the above-mentioned longer-side member and has a second engaging groove for engagement with the above-mentioned disk drive body. The second engaging groove is formed so as to be smaller than the above-mentioned first engaging groove. Also in the inventions of these aspects, to facilitate the detachment of the decorative panel, the second engaging piece and the like are formed so as to be smaller than the first engaging piece and the like, in order to employ primarily the first engaging piece or the first engaging groove and employ secondarily the second engaging piece or the second engaging groove. This enables to retain the state in which the decorative panel is installed, while facilitating the detachment of the decorative panel.

In other aspect of the present invention, the above-mentioned disk drive body is disposed in the vicinity of the above-mentioned first engaging piece or the above-mentioned first engaging groove, in a state in which the above-mentioned decorative panel is installed on the disk drive body, and has a recess portion disposed so as to oppose to the above-mentioned shorter-side member. This invention is effective, for example, in detaching the decorative panel from the disk drive body. The decorative panel can be detached, for example, by putting a finger in the recess portion, followed by pressing the finger against the shorter-side member. It is therefore easy to detach the decorative panel.

### BRIEF DESCRIPTION OF THE DRAWINGS

FIG. 1 is a perspective view showing a floppy disk drive according to one preferred embodiment of the present invention;

FIG. 2 is a plan view of a main body of the floppy disk drive shown in FIG. 1;

FIG. 3 is a back view of the floppy disk drive shown in FIG. 1;

FIG. 4 is a side view of the floppy disk drive shown in FIG. 1;

FIG. 5 is a sectional view taken on the line A-A of FIG. 3;

FIG. 6 is a partially enlarged view showing a state in which a decorative panel is installed in a drive body;

FIG. 7 is a partially enlarged view showing a back side of the main body of the floppy disk drive shown in FIG. 1;

FIG. 8 is a side view for explaining the operation when the decorative panel is detached from the main body; and

FIG. 9 is a partially enlarged view of a floppy disk drive according to other preferred embodiment of the present invention.

### DETAIL DESCRIPTION OF THE PREFERRED EMBODIMENTS

Preferred embodiments of the present invention will be described with reference to the accompanying drawings.

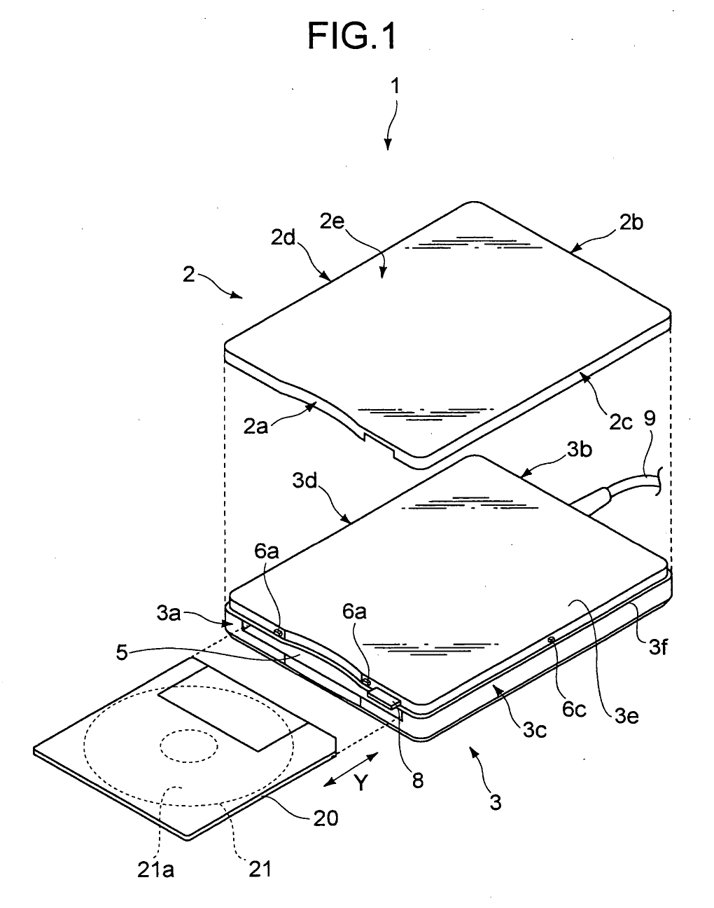

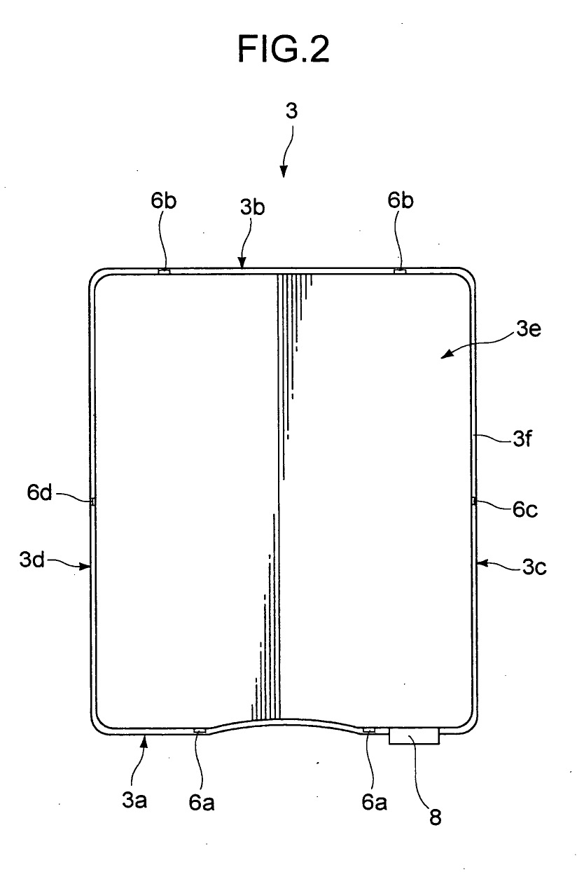

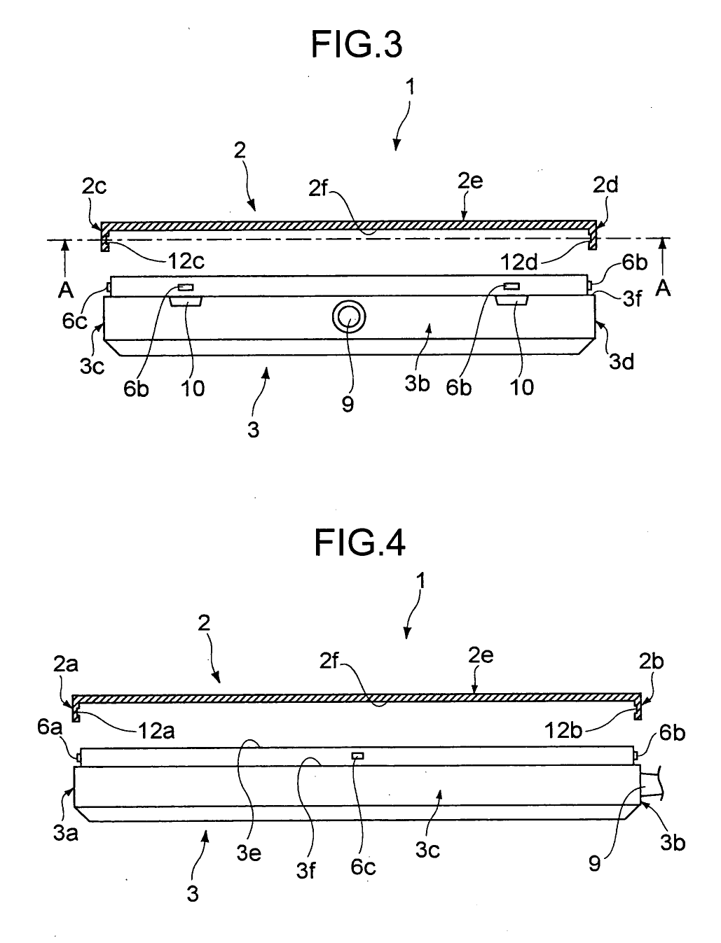

FIG. 1 is a perspective view of a disk drive according to one preferred embodiment of the present invention. In this embodiment, a description is now be made by taking a floppy disk drive (hereinafter referred to as a “FD drive”), as an example. FIG. 2 is a plan view showing a drive body 3 shown in FIG. 1. FIG. 3 and FIG. 4 are a back view and a side view of a FD drive 1, respectively.

The FD drive 1 has the drive body 3 and a decorative panel 2. The decorative panel 2 is constructed so as to be detachable from the drive body 3. A front face 3a of the drive body 3 is provided with an insertion opening 5, through which a floppy disk 20 can be inserted and ejected in the direction indicated by the double-headed arrow Y. The front face 3a of the drive body 3 is also provided with an eject button 8. By pressing the eject button 8, the floppy disk 20 inserted in the drive body 3 is ejected. In general, the floppy disk 20 contains a disk-like magnetic recording medium 21 that can record data. The disk-like recording medium 21 has a face 21a serving as a recording surface of data.

The front face 3a of the drive body 3 is provided with engaging pieces 6a for engagement with the decorative panel 2. Engaging pieces 6b are disposed in a back face 3b of the drive body 3, as shown in FIGS. 2, 3, and 4. For example, there are disposed two engaging pieces 6a and 6b, respectively. Engaging pieces 6c and 6d for engagement with the decorative panel 2 are disposed at both side faces 3c and 3d of the drive body 3, respectively. For example, the engaging pieces 6c and 6d are disposed one each. An upper face 3e of the drive body 3 has a flat shape, and a step portion 3f extends from the upper face 3e to each of the side faces 3a to 3d.

The back face 3b of the drive body 3 has a recess portion 10 for receiving the tip of a finger or a nail. The recess portion 10 is disposed by two, for example, so as to correspond to the engaging piece 6b, such that they are opposed to the shorter-side members 2b of the decorative panel 2 (for example, see FIG. 1), in a state in which the decorative panel 2 is installed on the drive body 3. An USB (universal serial bus) cable 9 to be connected to, for example, a personal computer (not shown) is disposed at approximately the center of the back face 3b. Of course, this cable should not be limited to the USB.

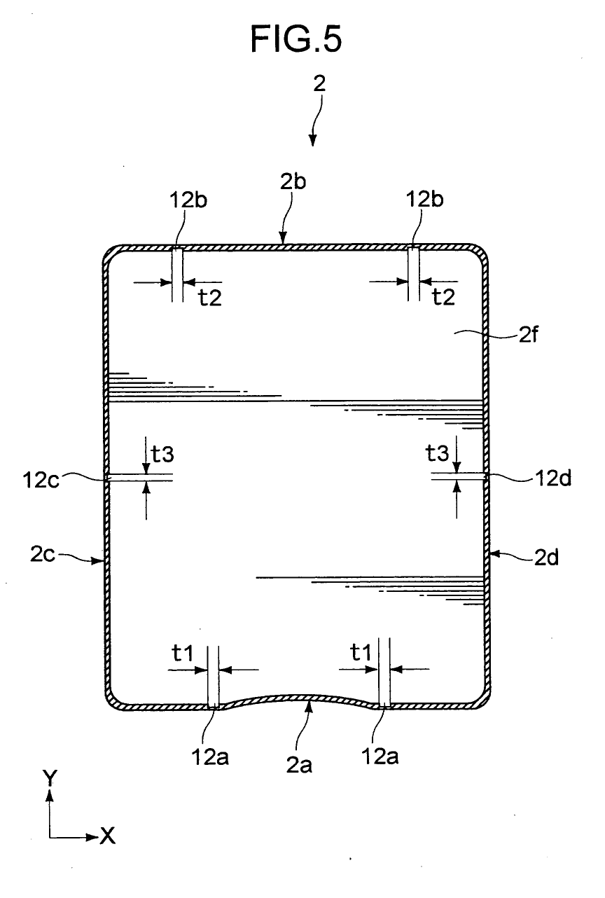

FIG. 5 is a sectional view taken on the line A-A in the decorative panel 2 shown in FIG. 3. In the decorative panel 2, a color, a pattern and the like are applied to the rectangular flat panel portion 2e. A color, a pattern and the like may be applied to other portions, besides the flat panel portion 2e. The decorative panel 2 is shaped in the form of a lid by having shorter-side members 2a and 2b, and the longer-side members 2c and 2d. When the decorative panel 2 is installed on the drive body 3, the shorter-side member 2a corresponds to the front face 3a of the drive body 3, and the shorter-side member 2b corresponds to the back face 3b of the drive body 3. Likewise, the longer-side member 2c corresponds to the side face 3c of the drive body 3, and the longer-side member 2d corresponds to the side face 3d of the drive body 3. The alphanumerical character 2f indicates a face opposing to the upper face 3e of the drive body 3, in a state in which the decorative panel 2 is installed on the drive body 3.

Referring to FIGS. 3, 4, and 5, the internal portions of the shorter-side members 2a and 2b of the decorative panel 2 have engaging grooves 12a and 12b as the first engaging grooves to be engaged with the above-mentioned engaging pieces 6a and 6b of the drive body 3, respectively. The engaging grooves 12a and 12b are disposed by two each, for example. The internal portions of the longer-side members 2c and 2d also have engaging grooves 12c and 12d as the second engaging grooves to be engaged with the above-mentioned engaging pieces 6c and 6d of the drive body 3, respectively. The engaging grooves 12c and 12d are disposed by one each, for example.

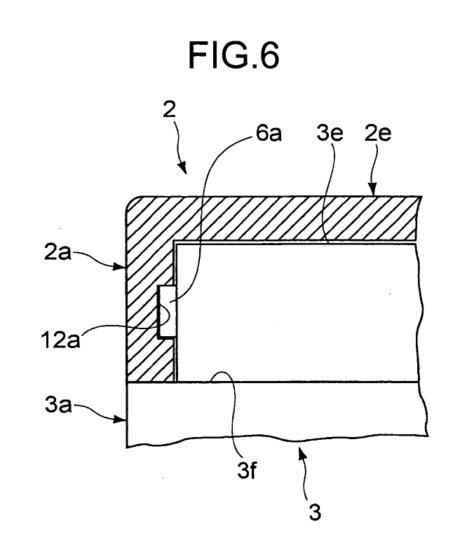

FIG. 6 is a partially enlarged view showing a state in which the decorative panel 2 is installed on the drive body 3. In FIG. 6, a portion of the front face 3a of the drive body 3 is viewed from the side face 3c. The decorative panel 2 can be installed on the drive body 3 by having the engaging piece 6a fit in the engaging groove 12a.

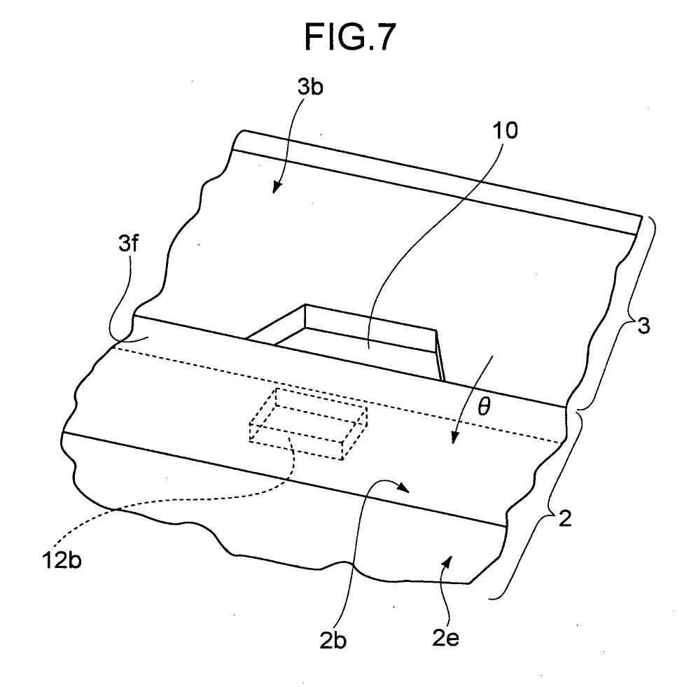

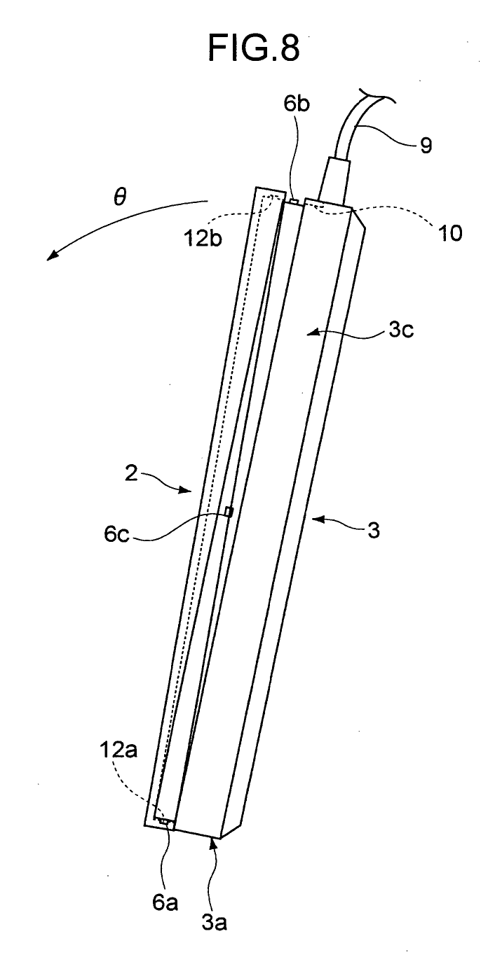

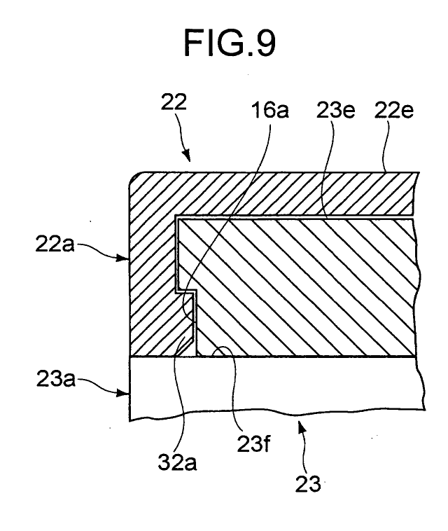

The following is the operation of detaching the decorative panel 2 from the drive body 3. FIG. 7 is a partially enlarged view showing the back face 3b of the drive body 3, in a state in which the decorative panel 2 is installed on the drive body 3. The engaged state between the engaging piece 6b and the engaging groove 12b is released by, for example, putting the tip of a finger or nail in the recess portion 10, and extruding the shorter-side member 2b on the back side of the decorative panel 2 in the direction indicated by the arrow θ. In this case, the vicinity of the shorter-side member 2a on the front side becomes a rotation axis of the decorative panel 2 and functions to rotate the decorative panel 2. Thus, a rotational action in the direction θ occurs, so that the engagements between the engaging pieces 6c and 6d disposed at the side faces 3c and 3d of the drive body 3, and the engaging grooves 12c and 12d disposed at the longer-side members 2c and 2d of the decorative panel 2 are respectively released naturally, as shown in FIG. 8. In this preferred embodiment, the presence of the recess portion 10 facilitates the detachment of the decorative panel 2 from the drive body 3.

Further, in this preferred embodiment, the detachment of the decorative panel 2 from the drive body 3 is easy to be carried out by releasing the engagement from the shorter-side member 2b. This is because a greater moment of inertia is obtainable by taking the shorter-side member 2a as a rotation axis, than may be the case of taking the longer-side member 2c or 2d as a rotation axis.

Thereafter, the decorative panel 2 can be detached from the drive body 3 by, for example, gripping by one hand the side face 3c, 3d of the drive body 3, and gripping by the other hand the longer-side member 2c, 2d of the decorative panel 2, and applying force to the decorative panel 2 and the drive body 3 so as to further rotate the decorative panel 2 in the direction θ. Thus, in this preferred embodiment, when the decorative panel 2 is gripped by hand, as compared to the gripping of the shorter-side member 2a, 2b, the gripping of the longer-side member 2c, 2d can minimize stretching of fingers, thereby facilitating the detachment. In particular, this effect is significant for large-size equipment such as a FD drive and a CD-ROM drive.

The following is the operation of installing the decorative panel 2 in the drive body 3. First, the shorter-side member 2a on the front side is installed on the front face 3a of the drive body 3 (i.e., bringing about the engagement between the engaging piece 6a and the engaging groove 12a), and the decorative panel 2 is rotated by taking the vicinity of the shorter-side member 2a, as a rotation axis (in the reverse direction of the direction θ shown in FIG. 8). Then, the shorter-side member 2b on the back side is installed on the back face 3b of the drive body 3 (i.e., bringing about the engagement between the engaging piece 6b and the engaging groove 12b), thereby installing the decorative panel 2 on the drive body 3.

Alternatively, the shorter-side member 2b on the back side may first be installed, and then the shorter-side member 2a on the front side be installed. In such an installation operation, the installation is facilitated by gripping by one hand the side face 3c, 3d of the drive body 3, and gripping by the other hand the longer-side member 2c, 2d of the decorative panel 2, and rotating the decorative panel 2 in the reverse direction of the direction θ shown in FIG. 8. In the case of gripping the decorative panel 2 by hands, as compared to the gripping of the two shorter-side members 2a, 2b, the gripping of the two longer-side members 2c, 2d can minimize stretching of fingers, thereby facilitating the installation.

Although the installation and the detachment operations of the decorative panel 2 have been described above, the above-mentioned operational effect is obtainable by employing the construction that the engaging piece 6b (or 6a) is disposed at the back face 3b (or the front face 3a) of the drive body 3, and the engaging groove 12b (or 12a) is disposed at the shorter-side member 2b (or 2a) of the decorative panel 2. In other words, the engaging pieces 6c, 6d disposed in the side faces 3c, 3d, and the engaging grooves 12c, 12d disposed at the longer-side members 2c, 2d are mere auxiliaries of the engaging piece 6b and the like, and the engaging groove 12b and the like. That is, the engaging pieces 6c, 6d, and the engaging grooves 12c, 12d are provided in order to avoid that the decorative panel 2 departs suddenly from the drive body 3, and in order to reliably retain the installed state. Therefore, the engaging pieces 6c, 6d, and the engaging grooves 12c, 12d are unnecessary if the installed state can be retained reliably.

As a means for employing primarily the engaging piece 6b and the like, and the engaging groove 12 and the like, and employing secondarily the engaging pieces 6c, 6d, and the engaging grooves 12c, 12d, there is the following means. For example, as shown in FIG. 5, it is constructed so as to be t1>t3, where t1 is the width of the engaging groove 12a in the direction X, and t3 is the width of the engaging grooves 12c and 12d in the direction Y. Similarly, it is constructed so as to be t2>t3, where t2 is the width of the engaging groove 12b in the direction X. Irrespective of the relationship between t1 and t2, they may be the same. Thus, by allowing the engaging grooves and the like to have different widths between the shorter-side and the longer-side, it is able to have the primary and secondary relationship between the two. Not only the width of the engaging groove, but also its depth and the like may be different from each other.

As other means for having the primary and secondary relationship, in this preferred embodiment, the number of the engaging piece 6b and the like, and the number of the engaging groove 12b and the like are less than the number of the engaging pieces 6c, 6d, and the engaging grooves 12c, 12d. Thus, by having the primary and secondary relationship between the shorter-side and the longer-side, it is capable of reliably retaining a state in which the decorative panel 2 is installed in the drive body 3, while facilitating the installation and the detachment of the decorative panel 2.

In the foregoing preferred embodiment, the decorative panel 2 is detachable so as to cover approximately the entire surface of the upper face 3e of the drive body 3 that is substantially parallel to the recording surface 21a of the floppy disk 20. The preparation of a variety of the decorative panels 2 having, for example, different patterns, colors or shapes enables to provide a disk drive to user's taste.

In this preferred embodiment, for example, the upper face 3e of the drive body 3 occupies the largest surface in the surface of the drive body 3. In accordance with this preferred embodiment, it is therefore able to further improve aesthetic sense than the case with conventional ones. For example, even for disk drives having the same shape and the like, the aesthetic sense of user can be shown more strongly depending on the selection of the decorative panel 2, thereby improving seasoning of user.

In this preferred embodiment, in the cases where the FD drive 1 is used by connecting to, for example, a personal computer or the like (not shown), the decorative panel 2 is selectable in accordance with the peripheral environment. For example, it is possible to have unification with the color and the pattern of the appearance of the personal computer. In this preferred embodiment, the decorative panel 2 can easily be detached from the drive body 3, without the need for a jig and an additional component.

The foregoing preferred embodiment should not be viewed as limiting the present invention, and various modifications may be made in the present invention. For example, the engaging pieces 6a, 6b, 6c, 6d, and the engaging grooves 12a, 12b, 12c, 12d should not be limited to the above-mentioned shapes. As shown in FIG. 9, there is disposed an engaging piece 32a formed by shaping the tip of a shorter-side member 22a of a decorative panel 22 like a pawl, so as to engage against an engaging groove 16a disposed on a front face 23a of a drive body 23. In this case, the engaging piece 32a may be formed continuously in the direction along with the side of the shorter-side member 22a, alternatively, may be formed at a plurality of positions, or may be formed only one. This is true for the longer-side member (not shown in FIG. 9).

In the foregoing embodiment, the engaging pieces 6a, 6b and the like are disposed on the drive body 3, and the engaging grooves 12a, 12b and the like are disposed at the decorative panel 2. Instead of being restricted to this, the engaging piece may be disposed at the decorative panel 2, and the engaging groove may be disposed on the drive body 3. Of course, both of the engaging piece and the engaging groove may be disposed on the decorative panel 2.

For example, the number of the engaging pieces 6a, 6b should not be limited to two each, and may be more than two. Alternatively, their respective number may be different between the front side and the back side. For example, the number of the engaging pieces 6a is two, and that of the engaging piece 6b is three. In response to these, the engaging grooves 12a, 12b of the decorative panel 2 may be different in number. This is true for the engaging pieces 6c, 6d, and the engaging grooves 12c, 12d.

Although in the foregoing preferred embodiment, the recess portion 10 is disposed on the back face 3b, it may be disposed on the front face 3a. Alternatively, the recess portion 10 may be disposed on both of the front face 3a and the back face 3b.

What is claimed is:

1. A disk drive apparatus comprising:
a disk drive body including a front face having an insertion opening of a disk and side faces substantially parallel to a recording surface of the inserted disk; and
a decorative panel covering approximately the entire surface of the side faces and being disposed so as to be detachable from the side faces.

2. The disk drive apparatus as cited in claim 1, wherein said decorative panel comprises:
a flat panel portion shaped as a rectangle by having a periphery thereof longer-sides and shorter-sides;
shorter-side members disposed along the shorter-sides of the flat panel portion;
longer-side members disposed along the longer-sides of the flat panel portion; and
one of a first engaging piece and a first engaging groove provided at said shorter-side members for engagement with the disk drive body.

3. The disk drive apparatus as cited in claim 2, wherein said decorative panel further comprises:
a plurality of said one of first engaging pieces and first engaging grooves; and
second engaging pieces for engagement with the above-mentioned disk drive body, the number of which is less than the number of said one of the first engaging pieces and the first engaging grooves, and being disposed at the longer-side members.

4. The disk drive apparatus as cited in claim 2, wherein said decorative panel further comprises:
a plurality of said one of first engaging pieces and first engaging grooves;
second engaging grooves for engagement with the disk drive body, the number of which is less than the number of said one of first engaging pieces and the first engaging grooves, and being disposed at the longer-side members.

5. The disk drive apparatus as cited in claim 2, wherein
said decorative panel is disposed at the longer-side members and has a second engaging piece for engagement with the disk drive body; and
the second engaging piece is formed so as to be smaller than the first engaging piece.

6. The disk drive apparatus as cited in claim 2, wherein said decorative panel is disposed at the longer-side member and has a second engaging groove for engagement with the disk drive body; and
the second engaging groove is formed so as to be smaller than the first engaging groove.

7. The disk drive apparatus as cited in claim 2, wherein
said disk drive body is disposed in the vicinity of said one of first engaging piece and first engaging groove in a state in which the decorative panel is installed on the disk drive body, and has a recess portion disposed so as to oppose to the shorter-side member.
